(19) United States
(12) Patent Application Publication
(10) Pub. No.: US 2026/0135468 A1
(43) Pub. Date: May 14, 2026

(54) INVERTER DRIVING APPARATUS, INVERTER CONTROL METHOD THEREOF, AND VEHICLE INCLUDING SAME

(71) Applicants: HYUNDAI MOTOR COMPANY, SEOUL (KR); KIA CORPORATION, SEOUL (KR)

(72) Inventors: Tae Jun Moon, Hwaseong-si (KR); Ho Rim Choi, Hwaseong-si (KR); Jin Wook Kang, Hwaseong-si (KR); Tae Gyeom Woo, Hwaseong-si (KR); Tae Il Yoo, Hwaseong-si (KR); Sang Woo Park, Hwaseong-si (KR)

(73) Assignees: HYUNDAI MOTOR COMPANY, SEOUL (KR); KIA CORPORATION, SEOUL (KR)

(21) Appl. No.: 19/225,780

(22) Filed: Jun. 2, 2025

(30) Foreign Application Priority Data
Nov. 11, 2024 (KR) 10-2024-0159445

(51) Int. Cl. H02M 1/088; H02M 1/00; H02M 7/493

(52) U.S. Cl. CPC H02M 1/088; H02M 1/0012; H02M 1/0025; H02M 7/493

(57) ABSTRACT

An inverter driving apparatus is capable of resolving current imbalance of power modules having different threshold voltages for an inverter including a plurality of power modules connected in parallel. The inverter driving apparatus includes a gate driver configured to output a gate voltage to the plurality of power modules and monitor threshold voltages of the plurality of power modules, and a controller configured to output a PWM (Pulse Width Modulation) signal to the gate driver in response to a command input from the outside and output a voltage control signal to the gate driver, based on the threshold voltages. The gate driver may be configured to output the gate voltage, based on a feedback gate voltage that includes feedback regarding the gate voltage, the PWM signal, and the voltage control signal.

### CROSS REFERENCE TO RELATED APPLICATIONS

The present application is based on and claims the benefit of priority under 35 U.S.C. § 119 to Korean Patent Application No. 10-2024-0159445, filed on Nov. 11, 2024, in the Korean Intellectual Property Office, the disclosure of which is herein incorporated by reference in its entirety.

### TECHNICAL FIELD

The present disclosure is related to inverter control and, more specifically, to an inverter driving apparatus capable of resolving current imbalance of power modules having different threshold voltages for an inverter including a plurality of power modules connected in parallel, an inverter control method thereof, and a vehicle including the same.

### BACKGROUND

An inverter implemented in vehicles may be used to drive the motor by converting DC voltage of a high-voltage battery into AC voltage. The inverter may include a plurality of power modules connected in parallel and may operate according to the control signal (or control voltage) output from a gate driver.

The gate driver may output a control signal to gate terminals of a plurality of power modules in response to a PWM (Pulse Width Modulation) signal provided from a controller, and the plurality of power modules may be turned on or off in response to the control signal of the gate driver.

In the structure of an inverter where multiple power modules are connected in parallel, current imbalance may cause damage to the power modules.

Current imbalance may be sufficiently considered during the design stage and corrected after identifying the problems thereof, but the problem with current imbalance due to the threshold voltage distribution of the power modules is difficult to identify and not easy to manage.

Therefore, a solution capable of solving the problem of current imbalance due to the threshold voltage distribution of the power modules is required.

The foregoing described as the background art is intended merely to aid in the understanding of the background of the present disclosure, and is not intended to mean that the present disclosure falls within the purview of the related art already known to those skilled in the art.

### SUMMARY

The embodiment disclosed in the present disclosure has been proposed in accordance with the aforementioned needs, and the present disclosure is to provide an inverter driving apparatus capable of resolving current imbalance of power modules having different threshold voltages for an inverter including a plurality of power modules connected in parallel, an inverter control method thereof, and a vehicle including the same.

The present disclosure is to provide an inverter driving apparatus capable of resolving current imbalance of power modules having different threshold voltages by changing the gate voltage applied to the power module depending on the threshold voltage of the power module, an inverter control method thereof, and a vehicle including the same.

The technical subjects pursued in the present disclosure may not be limited to the above-mentioned technical subjects, and other technical subjects which are not mentioned may be clearly understood from the following descriptions by those skilled in the art to which the present disclosure pertains.

An inverter driving apparatus according to the embodiment of the present disclosure is an apparatus for driving an inverter including a plurality of power modules connected in parallel, and may include a gate driver configured to output a gate voltage to the plurality of power modules and monitor threshold voltages of the plurality of power modules, and a controller configured to output a PWM (Pulse Width Modulation) signal to the gate driver in response to a command input from the outside and output a voltage control signal to the gate driver, based on the threshold voltages, and the gate driver may output the gate voltage, based on a feedback gate voltage that is feedback on the gate voltage, the PWM signal, and the voltage control signal.

According to the embodiment of the present disclosure, the controller may determine a delay time, based on the threshold voltage for each power module, determine the gate voltage corresponding to the delay time, and output the voltage control signal corresponding to the determined gate voltage to the gate driver.

According to the embodiment of the present disclosure, the controller may determine the delay time, based on a slope characteristic of a gate-source voltage of the power module.

According to the embodiment of the present disclosure, the controller may determine the delay time, based on Equation 1 below.

$$delay = \frac{Vth 1 - Vth 2}{d Vgs / dt} ( Vth 1 > Vth 2 ) \qquad Equation 1$$

Here, Vth1 is a threshold voltage of a first power module, Vth2 is a threshold voltage of a second power module, and dVgs/dt is a current flowing through a gate resistor Rg.

According to the embodiment of the present disclosure, the controller may determine the delay time corresponding to the threshold voltage, based on a table configured as delay times for respective threshold voltages.

According to the embodiment of the present disclosure, the gate driver may include a gate voltage generation circuit configured to receive the PWM signal and the voltage control signal, receive input of the feedback gate voltage, and output the gate voltage.

According to the embodiment of the present disclosure, the gate voltage generation circuit may include a source voltage generation circuit configured to receive the voltage control signal, receive input of the feedback gate voltage, and change the feedback gate voltage according to the voltage control signal to output a PWM source voltage, a PWM voltage generation circuit configured to receive the PWM signal, receive input of the PWM source voltage, and change the PWM source voltage according to the PWM signal to output a PWM voltage, and a gate voltage output circuit configured to receive the PWM voltage and output the gate voltage, based on the PWM voltage.

According to the embodiment of the present disclosure, the source voltage generation circuit may include a source voltage output circuit disposed between and connected to an input terminal to which the feedback gate voltage is input and ground, and configured to output the PWM source voltage in response to the voltage control signal.

According to the embodiment of the present disclosure, the source voltage output circuit may include a plurality of voltage distribution resistors, at least one voltage distribution switch, an output terminal, and at least one output node connected to the output terminal, and the source voltage output circuit may output the voltage distributed to the at least one output node, as the PWM source voltage, depending on a state of the at least one voltage distribution switch.

According to the embodiment of the present disclosure, the at least one voltage distribution switch may be turned on or off depending on the voltage control signal.

According to the embodiment of the present disclosure, the gate driver may include a threshold voltage monitoring circuit configured to monitor the threshold voltages of the plurality of power modules, convert the monitored threshold voltages into digital signals, and provide the same to the controller.

According to the embodiment of the present disclosure, the threshold voltage monitoring circuit may monitor a voltage of a gate resistor disposed between and connected to the gate driver and a gate terminal of the power module in a state where a switching element disposed between and connected to the gate terminal and a drain terminal of the power module is closed.

According to the embodiment of the present disclosure, the inverter may include a plurality of module groups including a plurality of power modules connected in parallel, and the gate driver may be connected to each of the plurality of gate module groups. In addition, the threshold voltage monitoring circuit of each of the plurality of gate drivers may monitor the threshold voltages for the plurality of power modules in the connected module groups.

An inverter driving method according to the embodiment of the present disclosure is a method for controlling an inverter including a plurality of power modules connected in parallel, and may include outputting a gate voltage to the plurality of power modules and monitoring threshold voltages of the plurality of power modules by a gate driver under control of a controller, outputting a PWM (Pulse Width Modulation) signal to the gate driver in response to a command input from the outside by the controller, outputting a voltage control signal to the gate driver, based on the threshold voltages, by the controller; and outputting the gate voltage, based on the PWM signal, the voltage control signal, and a feedback gate voltage that is feedback on the gate voltage.

A vehicle according to the embodiment of the present disclosure is a vehicle including an inverter including a plurality of power modules connected in parallel, and an inverter driving apparatus for controlling the inverter, and the inverter driving apparatus may include a gate driver configured to output a gate voltage to the plurality of power modules and monitor threshold voltages of the plurality of power modules, and a controller configured to output a PWM (Pulse Width Modulation) signal to the gate driver in response to a command input from the outside and output a voltage control signal to the gate driver, based on the threshold voltages, and the gate driver may output the gate voltage, based on a feedback gate voltage that is feedback on the gate voltage, the PWM signal, and the voltage control signal.

In addition to the above-mentioned solutions to the technical subjects, detailed particulars according to various embodiments of the present disclosure are included in the following description and the accompanying drawings.

According to the embodiment of the present disclosure, it is possible to provide an inverter driving apparatus capable of resolving current imbalance of power modules having different threshold voltages for an inverter including a plurality of power modules connected in parallel, an inverter control method thereof, and a vehicle including the same.

According to the embodiment of the present disclosure, it is possible to provide an inverter driving apparatus capable of resolving current imbalance of power modules having different threshold voltages by changing a gate voltage applied to the power module depending on the threshold voltage of the power module, an inverter control method thereof, and a vehicle including the same.

According to the embodiment of the present disclosure, since the inverter driving apparatus generates a gate voltage by reflecting differences in threshold voltage among a plurality of power modules connected in parallel, it is possible to improve the current imbalance of power modules that may occur due to the threshold voltages of the power modules connected in parallel.

The improvement of the current imbalance of the power modules is able to improve the efficiency of inverter control through current peak reduction and gate resistance optimization, and the stability of the inverter is able to be improved.

When the inverter driving apparatus and the inverter control method according to the embodiment of the present disclosure are applied to a vehicle, it is possible to stably drive a device (e.g., a motor) driven by the inverter, thereby improving the vehicle performance.

Advantageous effects obtainable from the present disclosure may not be limited to the above-mentioned effects, and other effects which are not mentioned may be clearly understood from the following descriptions by those skilled in the art to which the present disclosure pertains.

### BRIEF DESCRIPTION OF THE FIGURES

The above and other aspects, features, and advantages of the present disclosure will be more apparent from the following detailed description taken in conjunction with the accompanying drawings, in which:

FIG. 1 is a diagram illustrating the configuration of an inverter driving system including an inverter driving apparatus according to an embodiment of the present disclosure;

FIG. 2 is a diagram illustrating the configuration of a unit gate driver UGD according to an embodiment of the present disclosure;

FIG. 3 is a diagram illustrating the configuration of a source voltage generation circuit according to an embodiment of the present disclosure;

FIG. 4 is a diagram illustrating a method of monitoring a threshold voltage Vth in an embodiment of the present disclosure;

FIG. 5 is a diagram illustrating a gate-source voltage Vgs_1 according to a gate voltage input to a power module;

FIG. 6 is a diagram illustrating a current Id_1 flowing through a power module in response to the gate-source voltage in FIG. 5;

FIG. 7 is a diagram illustrating a gate-source voltage Vgs_2 when the gate voltage applied to FIG. 5 and FIG. 6 is changed according to an embodiment of the present disclosure and input to a power module; and

FIG. 8 is a diagram illustrating a current Id_2 flowing through a power module in response to the gate-source voltage Vgs_2 in FIG. 7.

### DETAILED DESCRIPTION

In describing the embodiments set forth herein, a detailed description of known functions or configurations incorporated herein will be omitted when it is determined that the description may make the subject matter of the embodiments set forth herein unclear. In addition, it should be appreciated that the accompanying drawings are provided only for the sake of easy understanding of the embodiments set forth herein, and the technical idea of the present disclosure is not limited to the accompanying drawings and includes all modifications, equivalents, or alternatives falling within the spirit and scope of the present disclosure.

Terms including an ordinal number such as “a first” and “a second” may be used to describe various elements, but the elements are not limited to the terms. The above terms are used merely for the purpose of distinguishing one element from other elements.

A singular expression may include a plural expression unless they are definitely different in a context.

As used herein, the expression “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

The terms “module” and “unit” used for the elements in the following description are given or interchangeably used in consideration of only the ease of writing the specification, and do not have distinct meanings or roles by themselves.

In the case where an element is referred to as being “connected” or “coupled” to any other elements, it should be understood that not only the element may be directly connected or coupled to the other elements, but also another element may exist therebetween. On the contrary, in the case where an element is referred to as being “directly connected” or “directly coupled” to any other element, it should be understood that no other element exists therebetween.

Hereinafter, embodiments set forth herein will be described in detail with reference to the accompanying drawings, and the same or similar elements are given the same and similar reference numerals regardless of figure numbers, so duplicate descriptions thereof will be omitted.

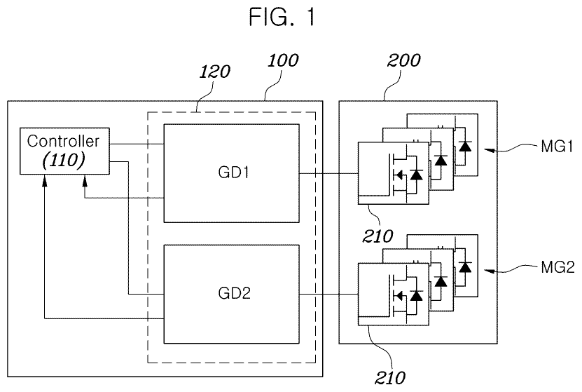

FIG. 1 is a diagram illustrating the configuration of an inverter driving system including an inverter driving apparatus 100 according to an embodiment of the present disclosure.

Referring to FIG. 1, the inverter driving apparatus 100 may be implemented to control an inverter 200. According to the embodiment, the inverter 200 may include a plurality of power modules 210 connected in parallel.

For example, the power module 210 may be a switching element implemented with an IGBT (Insulated Gate Bipolar Transistor), but the implementation example of the power module 210 is not limited to the IGBT.

For example, the inverter 200 may include a first module group MG1 including a plurality of power modules 210 connected in parallel, and a second module group MG2 including a plurality of power modules 210 connected in parallel, but the structure of the inverter 200 is not limited thereto. For example, the inverter 200 may include three or more module groups including multiple power modules connected in parallel.

For example, the inverter driving apparatus 100 and the inverter 200 according to the embodiment of the present disclosure may be implemented in a vehicle, and the inverter 200 may be implemented to control a driving motor of the vehicle. Furthermore, the field to which the inverter driving apparatus 100 and the inverter 200 according to the embodiment of the present disclosure are applied is not limited to a vehicle.

According to the embodiment, the inverter driving apparatus 100 may include a controller 110 and a gate driver 120.

The controller 110 may receive a command output from an upper controller, generate a PWM signal corresponding to the command, and output the generated PWM signal to the gate driver 120. For example, the upper controller may include a hybrid control unit (HCU), a vehicle control unit (VCU), an electric control unit (ECU), or the like.

According to the embodiment, the controller 110 may receive a threshold voltage Vth for each of the power modules 210 connected in parallel from the gate driver 120, and, based on the threshold voltage Vth for each power module 210, output a voltage control signal to the gate driver 120.

According to the embodiment, the controller 110 may determine a delay time on the basis of the threshold voltage Vth of each power module 210, determine a gate voltage corresponding to the determined delay time, and based on the determined gate voltage, output a voltage control signal to the gate driver 120.

For example, the gate voltage determined by the controller 110 corresponds to the gate voltage output from the gate driver 120 to the power module 210, and the controller 110 may output a voltage control signal to the gate driver 120 such that the gate voltage is output from the gate driver 120.

That is, the gate driver 120 may output the gate voltage in response to the voltage control signal of the controller 110.

As described above, the controller 110 according to the embodiment of the present disclosure may output the PWM signal and the voltage control signal to the gate driver 120.

According to the embodiment, the controller 110 may determine the delay time, based on the slope characteristic of a gate-source voltage Vgs of the power module 210.

For example, the controller 110 may determine the delay time, based on the following Equation 1.

$$delay = \frac{Vth 1 - Vth 2}{d Vgs / dt} ( Vth 1 > Vth 2 ) \qquad Equation 1$$

Here, Vth1 is a threshold voltage of a first power module, Vth2 is a threshold voltage of a second power module, and dVgs/dt is a current flowing through a gate resistor Rg.

According to the embodiment, the controller 110 may store a delay time for each Vth configured through experiments as a table. Accordingly, if the controller 110 receives the threshold voltage Vth from the gate driver 120, it may determine the delay time corresponding to the received threshold voltage Vth, based on the previously stored table.

According to the embodiment, the controller 110 may store a gate voltage for each delay time configured through experiments as a table.

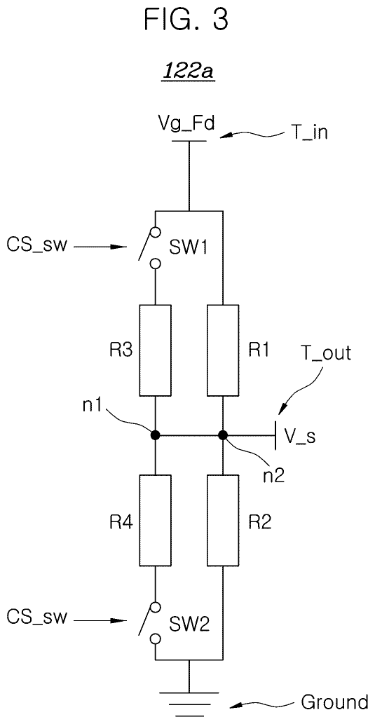

According to the embodiment, the controller 110 may store a source voltage for each gate voltage configured through experiments as a table, and may store a voltage control signal value for each source voltage. Here, the voltage control signal value may be the status value (on or off) of a voltage distribution switch SW1 or SW2 in FIG. 3, which will be described later.

The gate driver 120 may receive the PWM signal and voltage control signal output from the controller 110, and output the gate voltage to the inverter 200, based on the PWM signal and voltage control signal.

In this embodiment, although the gate driver 120 is illustrated as including a first gate driver GD1 connected to the first module group MG1, and a second gate driver GD2 connected to the second module group MG2, it is not limited thereto. For example, one gate driver 120 may be connected to all power modules 210 in the inverter 200.

For the convenience of explanation, the first gate driver GD1 and the second gate driver GD2 respectively connected to the multiple module groups MG1 and MG2 will be referred to as a “unit gate driver UGD”.

According to the embodiment, the gate driver 120 may receive feedback on the gate voltage output from the gate driver 120. Hereinafter, the gate voltage subject to feedback will be referred to as a “feedback gate voltage”.

According to the embodiment, the gate driver 120 may output a gate voltage, based on the feedback gate voltage, the PWM signal, and the voltage control signal.

The gate driver 120 may monitor the threshold voltage Vth for each of the plurality of power modules 210 connected in parallel, and provide the threshold voltage Vth for each of the plurality of power modules 210 connected in parallel to the controller 110.

For example, the gate driver 120 may convert the monitored threshold voltage Vth into a digital signal and provide it to the controller 110.

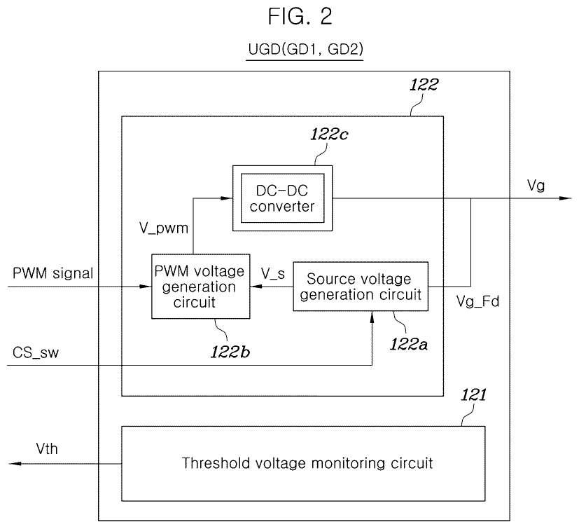

FIG. 2 is a diagram illustrating the configuration of a unit gate driver UGD according to an embodiment of the present disclosure.

Referring to FIG. 1 and FIG. 2, a unit gate driver UGD according to the embodiment of the present disclosure may include a threshold voltage monitoring circuit 121 and a gate voltage generation circuit 122.

The threshold voltage monitoring circuit 121 may monitor a threshold voltage Vth for each of a plurality of power modules 210 in a connected module group MG and provide the monitored threshold voltage Vth to the controller 110.

For example, the threshold voltage monitoring circuit 121 may convert the monitored threshold voltage Vth into a digital signal and provide it to the controller 110.

The gate voltage generation circuit 122 may receive a PWM signal and a voltage control signal CS_sw from the controller 110, and may receive a feedback gate voltage Vg_Fd.

The gate voltage generation circuit 122 may output a gate voltage Vg, based on the PWM signal, the voltage control signal CS_sw, and the feedback gate voltage Vg_Fd.

The gate voltage generation circuit 122 may change the feedback gate voltage Vg_Fd according to the voltage control signal CS_sw to generate a PWM source voltage V_s, generate a PWM voltage V_pwm on the basis of the PWM source voltage V_s and the PWM signal, and output a gate voltage Vg on the basis of the PWM voltage V_pwm.

According to the embodiment, the gate voltage generation circuit 122 may include a source voltage generation circuit 122a, a PWM voltage generation circuit 122b, and a gate voltage output circuit 122c.

The source voltage generation circuit 122a may receive the voltage control signal CS_sw, and may be applied with the feedback gate voltage Vg_Fd.

The source voltage generation circuit 122a may change the feedback gate voltage Vg_Fd according to the voltage control signal CS_sw, thereby generating a PWM source voltage V_s.

FIG. 3 is a diagram illustrating the configuration of a source voltage generation circuit 122a according to an embodiment of the present disclosure. The configuration of the source voltage generation circuit 122a is not limited thereto.

Referring to FIG. 3, the source voltage generation circuit 122a may include a source voltage output circuit C_s disposed between and connected to an input terminal T_in to which the feedback gate voltage Vg_Fd is input and the ground.

The source voltage output circuit C_s may include an output terminal T_out that outputs a PWM source voltage V_s, and one or more output nodes n1 and n2 connected to the output terminal T_out.

According to the embodiment, the source voltage output circuit C_s may include a plurality of voltage distribution resistors R1, R2, R3, and R4 and one or more voltage distribution switches SW1 and SW2, and the voltage distribution switches SW1 and SW2 may be turned on or off according to a voltage control signal CS_sw.

The source voltage output circuit C_s according to the embodiment may distribute a feedback gate voltage Vg_Fd, based on the plurality of voltage distribution resistors R1, R2, R3, and R4, depending on the states (turn-on or turn-off) of the voltage distribution switches SW1 and SW2, and output the voltage applied to the output nodes n1 and n2, as a PWM source voltage V_s, through the output terminal T_out.

In FIG. 3, the PWM source voltage V_s depending on the states of the voltage distribution switches SW1 and SW2 is shown in Table 1 below.

TABLE 1

| | SW1 | SW2 | V_s |
|---|---|---|---|
| State (On or Off) | Off | Off | $\frac{R 2}{R 2 + R 1} Vg \_ Fd$ |
| | Off | On | $\frac{R 2 / / R 4}{R 1 + R 2 / / R 4} Vg \_ Fd$ |
| | On | Off | $\frac{R 2}{R 2 + R 1 / / R 3} Vg \_ Fd$ |
| | On | On | $\frac{R 2 / / R 4}{R 1 / / R 3 + R 2 / / R 4} Vg \_ Fd$ |

Referring back to FIG. 2, the PWM voltage generation circuit 122b may receive a PWM signal from the controller 110 and may be applied with the PWM source voltage V_s output from the source voltage generation circuit 122a.

The PWM voltage generation circuit 122b may change the PWM source voltage V_s according to the PWM signal and output a PWM voltage V_pwm.

The gate voltage output circuit 122c may receive the PWM voltage V_pwm applied thereto and, based on the PWM voltage V_pwm, output a gate voltage Vg.

For example, the gate voltage output circuit 122c may be implemented as a DC-DC converter, and the configuration of the gate voltage output circuit 122c is not limited thereto.

For example, the gate voltage output circuit 122c may include a transformer, and may change the PWM signal V_pwm input to a primary circuit of the transformer according to a turn ratio, thereby outputting a gate voltage Vg to a secondary circuit of the transformer.

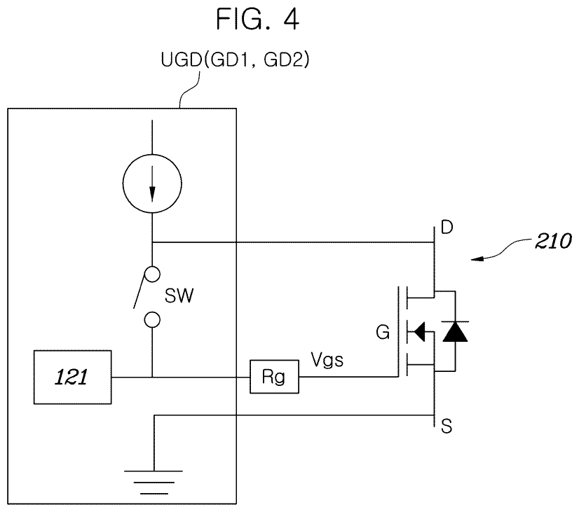

FIG. 4 is a diagram illustrating a method of monitoring a threshold voltage Vth in an embodiment of the present disclosure.

Referring to FIG. 4, the threshold voltage monitoring circuit 121 may be connected to a gate terminal G of each power module 210, and may monitor the voltage (gate-source voltage) Vgs between the gate terminal G and a source terminal S of the power module 210.

At this time, the threshold voltage monitoring circuit 121 may monitor the gate-source voltage Vgs of the power module 210 in the state where the switching element SW disposed between and connected to the gate terminal G and a drain terminal D of the power module 210 is closed (i.e., the gate terminal G and the drain terminal D are connected), and the gate-source voltage Vgs may become the threshold voltage Vth.

A gate resistor Rg may be disposed between the threshold voltage monitoring circuit 121 and an arbitrary node between the gate terminal G and the source terminal S of the power module 210, so that the threshold voltage monitoring circuit 121 may monitor the voltage generated at the gate resistor Rg.

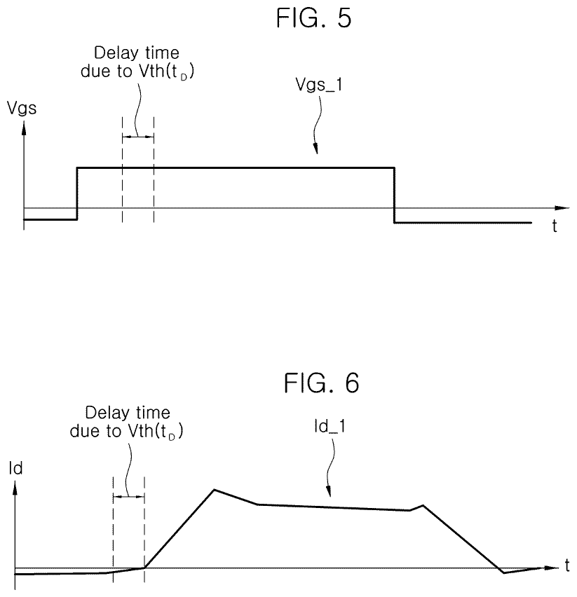

FIG. 5 is a diagram illustrating a gate-source voltage Vgs_1 according to a gate voltage input to a power module 210, and FIG. 6 is a diagram illustrating a current Id_1 flowing through a power module 210 in response to the gate-source voltage in FIG. 5.

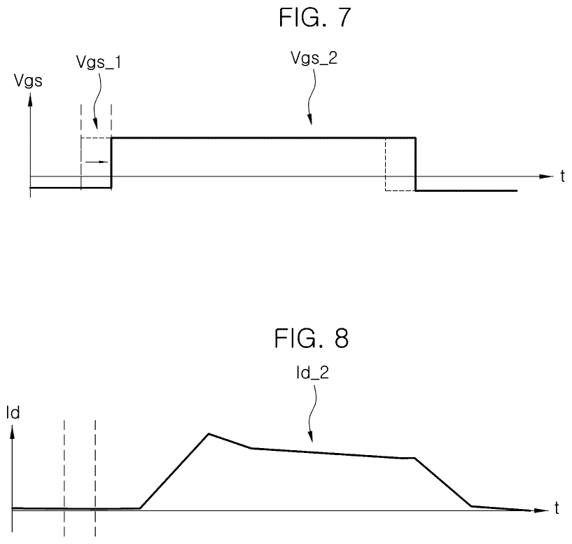

FIG. 7 is a diagram illustrating a gate-source voltage Vgs_2 when the gate voltage applied to FIG. 5 and FIG. 6 is changed according to an embodiment of the present disclosure and input to a power module 210, and FIG. 8 is a diagram illustrating a current Id_2 flowing through a power module 210 in response to the gate-source voltage Vgs_2 in FIG. 7.

As shown in FIG. 5 and FIG. 6, the current Id_1 flowing through the power module 210 may be delayed by the time TD delayed by the threshold voltage Vth of the power module 210.

On the other hand, since the gate voltage according to the embodiment of the present disclosure is generated based on the PWM signal by reflecting the time delayed by the threshold voltage Vth of the power module 210, as shown in FIGS. 7 and 8, the gate-source voltage Vgs_2 may be delayed and then turned on, so that the current Id_2 may flow to the power module 210 at a predetermined time.

In the embodiment of the present disclosure, the change of the gate voltage is performed based on the threshold voltage Vth of each of the plurality of power modules, and each of the plurality of power modules operates according to the gate voltage reflecting its own threshold voltage.

Therefore, even if the threshold voltage Vth differs among the plurality of power modules, the current may flow through the respective power modules at a predetermined time without time differences, so that the current imbalance may be resolved.

Meanwhile, the inverter control method according to the embodiment of the present disclosure may be implemented in a computer system or recorded on a recording medium. The computer system may include at least one processor, a memory, a user input device, a data communication bus, a user output device, and a storage. The respective components described above perform data communication through a data communication bus.

The computer system may further include a network interface coupled to a network. The processor may be a central processing unit (CPU) or a semiconductor device that processes instructions stored in the memory and/or storage.

The memory and storage may include various forms of volatile or nonvolatile storage media. For example, the memory may include a ROM and a RAM.

Therefore, the inverter control method according to the embodiment of the present disclosure may be implemented in a computer-executable manner. When the inverter control method according to the embodiment of the present disclosure is performed on a computer device, computer-readable instructions may perform the inverter control method according to the present disclosure.

Meanwhile, the inverter control method according to the present disclosure described above may be implemented as a computer-readable code on a computer-readable recording medium. The computer-readable recording medium includes all types of recording media on which data capable of being read by a computer system is stored. For example, there may be a ROM (Read Only Memory), a RAM (Random Access Memory), a magnetic tape, a magnetic disk, a flash memory, an optical data storage device, etc. In addition, the computer-readable recording medium may be distributed to a computer system connected to a computer communication network, and may be stored and executed as a code capable of being read in a distributed manner.

Although embodiments of the present disclosure have been described above with reference to the accompanying drawings, the present disclosure is not necessarily limited to these embodiments and various modifications and changes may be made thereto without departing from the technical idea of the present disclosure. Therefore, the embodiments set forth herein are not intended to limit the technical idea of the present disclosure but intended to explain the technical idea of the present disclosure, and the scope of the technical idea of the present disclosure is not limited by these embodiments. Accordingly, the embodiments as described above should be construed as being illustrative and non-limitative in all aspects. The scope of protection of the present disclosure should be de fined by the appended claims, and all technical ideas equivalent to the claims shall be construed as falling within the scope of protection of the present disclosure.

1. An apparatus for driving an inverter comprising a plurality of power modules connected in parallel, the apparatus comprising:
a gate driver configured to output a gate voltage to the plurality of power modules and to monitor a threshold voltage of each of the plurality of power modules; and
a controller configured to output a Pulse Width Modulation (PWM) signal to the gate driver in response to a command input from an upper controller, and to output a voltage control signal to the gate driver based on the threshold voltage of each of the plurality of power modules;
wherein the gate driver is configured to output the gate voltage, based on a feedback gate voltage that includes feedback regarding the gate voltage, the PWM signal, and the voltage control signal.

2. The apparatus according to claim 1, wherein the controller is configured to:
determine a delay time based on the threshold voltage of each of the plurality of power modules;
determine the gate voltage corresponding to the delay time; and
output the voltage control signal corresponding to the gate voltage to the gate driver.

3. The apparatus according to claim 2, wherein the controller is configured to determine the delay time based on a slope characteristic of a gate-source voltage of the power module.

4. The apparatus according to claim 3, wherein the controller is configured to determine the delay time based on
$$delay = \frac{Vth 1 - Vth 2}{d Vgs / dt} ( Vth 1 > Vth 2 ) ,$$
where Vth1 is a first threshold voltage of a first power module, Vth2 is a second threshold voltage of a second power module, and dVgs/dt is a current flowing through a gate resistor Rg.

5. The apparatus according to claim 3, wherein the controller is configured to determine the delay time corresponding to the threshold voltage of each of the plurality of power modules based on a table configured as delay times for each of the threshold voltages.

6. The apparatus according to claim 1, wherein the gate driver comprises a gate voltage generation circuit configured to:
receive the PWM signal and the voltage control signal;
receive input of the feedback gate voltage; and
output the gate voltage.

7. The apparatus according to claim 6, wherein the gate voltage generation circuit comprises a source voltage generation circuit configured to:
receive the voltage control signal;
receive input of the feedback gate voltage; and
change the feedback gate voltage according to the voltage control signal to output a PWM source voltage;
a PWM voltage generation circuit configured to:
receive the PWM signal;
receive input of the PWM source voltage; and
change the PWM source voltage according to the PWM signal to output a PWM voltage; and
a gate voltage output circuit configured to:
receive the PWM voltage; and
output the gate voltage based on the PWM voltage.

8. The apparatus according to claim 7, wherein the source voltage generation circuit comprises a source voltage output circuit disposed between and connected to an input terminal to which the feedback gate voltage is input and ground, and wherein the source voltage generation circuit is configured to output the PWM source voltage in response to the voltage control signal.

9. The apparatus according to claim 8, wherein:
the source voltage output circuit comprises a plurality of voltage distribution resistors, at least one voltage distribution switch, an output terminal, and at least one output node connected to the output terminal; and
the source voltage output circuit is configured to output a voltage distributed to the at least one output node, as the PWM source voltage, depending on a state of the at least one voltage distribution switch.

10. The apparatus according to claim 9, wherein the at least one voltage distribution switch is turned on or off based on the voltage control signal.

11. The apparatus according to claim 1, wherein the gate driver comprises a threshold voltage monitoring circuit configured to:
monitor the threshold voltages of the plurality of power modules;
convert the monitored threshold voltages into digital signals; and
provide the monitored threshold voltages to the controller.

12. The apparatus according to claim 11, wherein the threshold voltage monitoring circuit is configured to monitor a voltage of a gate resistor disposed between and connected to the gate driver and a gate terminal of each of the plurality of power modules in a state where a switching element disposed between and connected to the gate terminal and a drain terminal of each of the plurality of power modules is closed.

13. The apparatus according to claim 11, wherein the inverter comprises a plurality of module groups comprising a plurality of power modules connected in parallel;
wherein the gate driver is connected to each of the plurality of module groups; and
wherein the threshold voltage monitoring circuit of the gate driver is configured to monitor the threshold voltages for the plurality of power modules in the plurality of module groups.

14. A method for controlling an inverter comprising a plurality of power modules connected in parallel, the method comprising:
outputting, by a gate driver under control of a controller, a gate voltage to the plurality of power modules and monitoring threshold voltages of each of the plurality of power modules;
outputting, by the controller, a Pulse Width Modulation (PWM) signal to the gate driver in response to a command input from an upper controller;
outputting, by the controller, a voltage control signal to the gate driver, based on the threshold voltages of each of the plurality of power modules; and
outputting, by the gate driver, the gate voltage, based on the PWM signal, the voltage control signal, and a feedback gate voltage that includes feedback regarding the gate voltage.

15. The method according to claim 14, further comprising:
determining, by the controller, a delay time based on the threshold voltage of each of the plurality of power modules;
determining, by the controller, the gate voltage corresponding to the delay time; and
outputting, by the controller, the voltage control signal corresponding to the gate voltage to the gate driver.

16. The method according to claim 14, further comprising:
monitoring, by a threshold monitoring circuit, the threshold voltages of the plurality of power modules;
converting, by the threshold monitoring circuit, the monitored threshold voltages into digital signals; and
providing the monitored threshold voltages to the controller.

17. The method according to claim 16, further comprising:
monitoring, by threshold voltage monitoring circuit, a voltage of a gate resistor disposed between and connected to the gate driver and a gate terminal of each of the plurality of power modules in a state where a switching element disposed between and connected to the gate terminal and a drain terminal of each of the plurality of power modules is closed.

18. The method according to claim 16, further wherein the inverter comprises a plurality of module groups comprising a plurality of power modules connected in parallel;
wherein the gate driver is connected to each of the plurality of module groups; and
wherein the threshold voltage monitoring circuit of each of the plurality of gate drivers is configured to monitor the threshold voltages for the plurality of power modules in the plurality of module groups.

19. A vehicle comprising an inverter comprising a plurality of power modules connected in parallel, and an inverter driving apparatus for controlling the inverter, wherein the inverter driving apparatus comprises:
a gate driver configured to output a gate voltage to the plurality of power modules and to monitor threshold voltages of each of the plurality of power modules; and
a controller configured to output a Pulse Width Modulation (PWM) signal to the gate driver in response to a command input from an upper controller, and to output a voltage control signal to the gate driver, based on the threshold voltages of each of the plurality of power modules;
wherein the gate driver is configured to output the gate voltage, based on a feedback gate voltage that includes feedback regarding the gate voltage, the PWM signal, and the voltage control signal.

20. The vehicle according to claim 19, wherein the gate driver comprises a threshold voltage monitoring circuit configured to:
monitor the threshold voltages of the plurality of power modules;
convert the monitored threshold voltages into digital signals; and
provide the monitored threshold voltages to the controller.
